(19) United States
(12) Patent Application Publication
(10) Pub. No.: US 2025/0140838 A1
(43) Pub. Date: May 1, 2025

(54) POSITIVE ELECTRODE ACTIVE MATERIAL AND BATTERY

(71) Applicant: TOYOTA JIDOSHA KABUSHIKI KAISHA, Toyota-shi (JP)

(72) Inventors: Ryosuke OHSAWA, Okazaki-shi (JP); Takahiko NINOMIYA, Miyoshi-shi (JP); Taku KINOSHITA, Toyota-shi (JP)

(73) Assignee: TOYOTA JIDOSHA KABUSHIKI KAISHA, Toyota-shi (JP)

(21) Appl. No.: 18/901,179

(22) Filed: Sep. 30, 2024

(30) Foreign Application Priority Data
Oct. 27, 2023 (JP) 2023-184927

(51) Int. Cl. H01M 4/525; H01M 4/02; H01M 4/36; H01M 10/052

(52) U.S. Cl. CPC H01M 4/525; H01M 4/366; H01M 10/052; H01M 2004/021; H01M 2004/028

(57) ABSTRACT

A positive electrode active material includes a positive electrode active material particle that has a composition expressed as LiₓNiₐCo_{b}Mn_{c}M_{d}O_{y}, a sphericity standard deviation (Z) of the positive electrode active material particle satisfying Z≥0.018 (in the composition, 0.1≤x≤1.5, 0.5≤a≤1.0, 0≤b≤0.3, 0≤c≤0.3, 0≤d≤0.1, a+b+c+d=1.0, 1.5≤y≤2.1 are satisfied, and the M expresses at least one kind of element that is selected from the group consisting of B, Nb, W, Sr, Pr, La, Ba, Mg, Al, Zr, Sc, Ti, Y, Hf, and Sn).

### CROSS-REFERENCE TO RELATED APPLICATION

This application claims priority to Japanese Patent Application No. 2023-184927 filed on Oct. 27, 2023, incorporated herein by reference in its entirety.

### BACKGROUND

### 1. Technical Field

The present disclosure relates to a positive electrode active material and a battery.

### 2. Description of Related Art

Conventionally, a positive electrode active material in which various additive elements are added is used as a positive electrode active material for a battery that has a high resistance characteristic. Moreover, in such a positive electrode active material for the battery, the shape and others of the particle of the positive electrode active material are controlled.

For example, Japanese Unexamined Patent Application Publication No. 2014-139128 discloses a lithium-manganese composite oxide that has an average minor axis of 0.08 μm or more and 0.8 μm or less, an average major axis of 2 μm or more and 10 μm or less, and an average aspect ratio of 8 or more and 80 or less.

### SUMMARY

Conventionally, when a positive electrode active material layer in a battery is formed, a positive electrode active material is pressed and fixed. However, when the positive electrode active material is pressed, a strong force locally acts on particles of the positive electrode active material, and a crack can be generated on the particle. As a result, the durability of the battery can decrease, and the capacity of the battery can decrease after a charge-discharge cycle is repeated, for example. Therefore, a battery that restrains the generation of the crack on the particle in the positive electrode active material and thereby has a high durability is demanded.

The present disclosure has been made in view of the above circumstance, and has an object to provide a positive electrode active material in which the generation of the crack of the positive electrode active material particle is restrained, and a battery that has a high durability.

Means for solving the above problem includes the following aspects.
<1> A positive electrode active material comprising a positive electrode active material particle that has a composition expressed as LiₓNiₐCo_{b}Mn_{c}M_{d}O_{y}, a sphericity standard deviation (Z) of the positive electrode active material particle satisfying Z≥0.018 (in the composition, 0.1≤x≤1.5, 0.5≤a≤1.0, 0≤b≤0.3, 0≤c≤0.3, 0≤d≤0.1, a+b+c+d=1.0, 1.5≤y≤2.1 are satisfied, and the M expresses at least one kind of element that is selected from the group consisting of B, Nb, W, Sr, Pr, La, Ba, Mg, Al, Zr, Sc, Ti, Y, Hf, and Sn).
<2> The positive electrode active material according to <1>, wherein the sphericity standard deviation (Z) satisfies 0.090≤Z≤0.800.
<3> The positive electrode active material according to <1>, comprising: a first active material particle that includes a coating on a surface, the coating containing a compound of the element expressed as the M; and a second active material particle that does not include the coating on the surface.
<4> A battery comprising the positive electrode active material according to any one of <1> to <3>.

The present disclosure provides the positive electrode active material in which the generation of the crack of the positive electrode active material particle is restrained, and the battery that has a high durability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of a positive electrode active material according to an embodiment of the present disclosure;

FIG. 2 is a schematic sectional view showing a conventional positive electrode active material layer; and

FIG. 3 is a schematic sectional view showing a state where the conventional positive electrode active material layer has been pressed.

### DETAILED DESCRIPTION OF EMBODIMENTS

### Positive Electrode Active Material

A positive electrode active material according to an embodiment of the present disclosure includes a positive electrode active material particle that has a composition expressed as LiₓNiₐCo_{b}Mn_{c}M_{d}O_{y}, a sphericity standard deviation (Z) of the positive electrode active material particle satisfying Z>0.018 (in the composition, 0.1≤x≤ 1.5, 0.5≤a≤1.0, 0≤b≤0.3, 0≤c≤0.3, 0≤d≤0.1, a+b+c+d=1.0, 1.5≤y≤2.1 are satisfied, and the M expresses at least one kind of element that is selected from the group consisting of B, Nb, W, Sr, Pr, La, Ba, Mg, Al, Zr, Sc, Ti, Y, Hf, and Sn).

With the positive electrode active material according to the embodiment of the present disclosure, the generation of the crack of the particle is restrained, and when the positive electrode active material is used in a battery, the durability of the battery can be improved.

Conventionally, when a positive electrode active material layer to be used in a battery is formed, the positive electrode active material is pressed (compressed) and fixed. However, when the positive electrode active material is pressed, a strong force locally acts on particles of the positive electrode active material, and a crack can be generated on the particle. As a result, the durability of the battery can decrease (for example, the capacity of the battery can decrease after a charge-discharge cycle is repeated). This is thought to be because the sphericity standard deviation (Z) of the particle in the positive electrode active material is low (specifically, Z is lower than 0.018). The low sphericity standard deviation (Z) of the particle in the positive electrode active material means that the sphericity of the particle of the positive electrode active material is uniform. When the sphericity of the particle of the positive electrode active material on a current collector is uniform, voids among particles in the positive electrode active material are large, that is, the filling density is low. When the positive electrode active material is pressed in the state where voids among particles are large in this way, the strong force locally acts on particles, and the crack is generated on the positive electrode active material particle. It is thought that the durability of the battery including the positive electrode active material particle with the crack is low.

On the other hand, in the positive electrode active material according to the embodiment of the present disclosure, the sphericity standard deviation (Z) of the positive electrode active material particle is high, and is 0.018 or higher. That is, the sphericity is not uniform, and positive electrode active material particles having different sphericities are contained. Since positive electrode active material particles having different sphericities exist in this way, voids among particles in the positive electrode active material are filled, so that voids are small, that is, the filling density is high. When the positive electrode active material having a high filling density is pressed, the strong force is restrained from locally acting on particles, and the generation of the crack on the positive electrode active material particle is restrained. As a result, in the case where this positive electrode active material is used in the battery, it is possible to improve the durability of the battery (for example, it is possible to restrain the decrease in battery capacity after the charge-discharge cycle is repeated).

A specific example of the positive electrode active material according to the embodiment of the present disclosure will be described with use of the drawings.

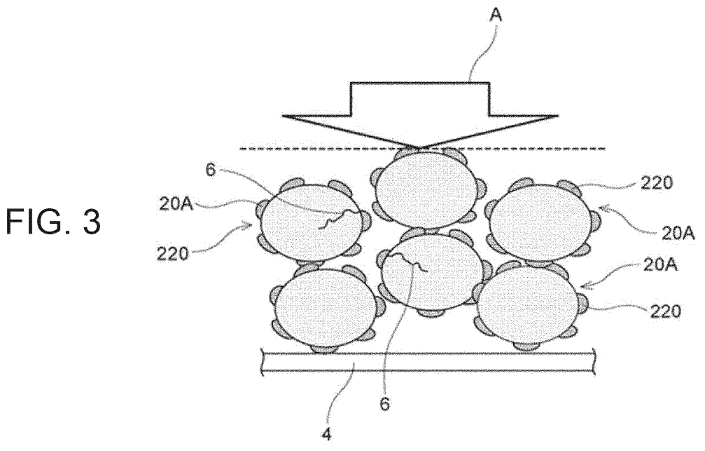

First, as the above-described conventional positive electrode active material in which the sphericity standard deviation (Z) of the particle is low (specifically, Z is lower than 0.018), for example, there is a positive electrode active material that includes a particle having a shape shown in FIG. 2 and FIG. 3. FIG. 2 is a schematic sectional view showing a conventional positive electrode active material layer, and FIG. 3 is a schematic sectional view showing a state where the conventional positive electrode active material layer has been pressed.

A positive electrode active material layer 20 shown in FIG. 2 is formed such that positive electrode active material particles 20A are accumulated on a current collector 4. The positive electrode active material particle 20A is an active material particle including, on the surface, coatings 220 each of which contains a compound of the element (also referred to as merely “M element”, hereinafter) expressed as the above-described M. Each positive electrode active material particle 20A included in the positive electrode active material layer 20 is an active material particle including, on the surface, the coatings 220 each of which contains the compound of the M element, and the sphericity standard deviation (Z) of the positive electrode active material particle 20A is low, and is lower than 0.018.

In the positive electrode active material layer 20 including only the positive electrode active material particle 20A having a low sphericity standard deviation (Z) as the active material, voids among positive electrode active material particles 20A are large, as shown in FIG. 2. When this positive electrode active material layer 20 is pressed (compressed) in the direction of an arrow A as shown in FIG. 3, the strong force locally acts on the positive electrode active material layer 20, so that a crack 6 can be generated on the positive electrode 10 active material particle 20A.

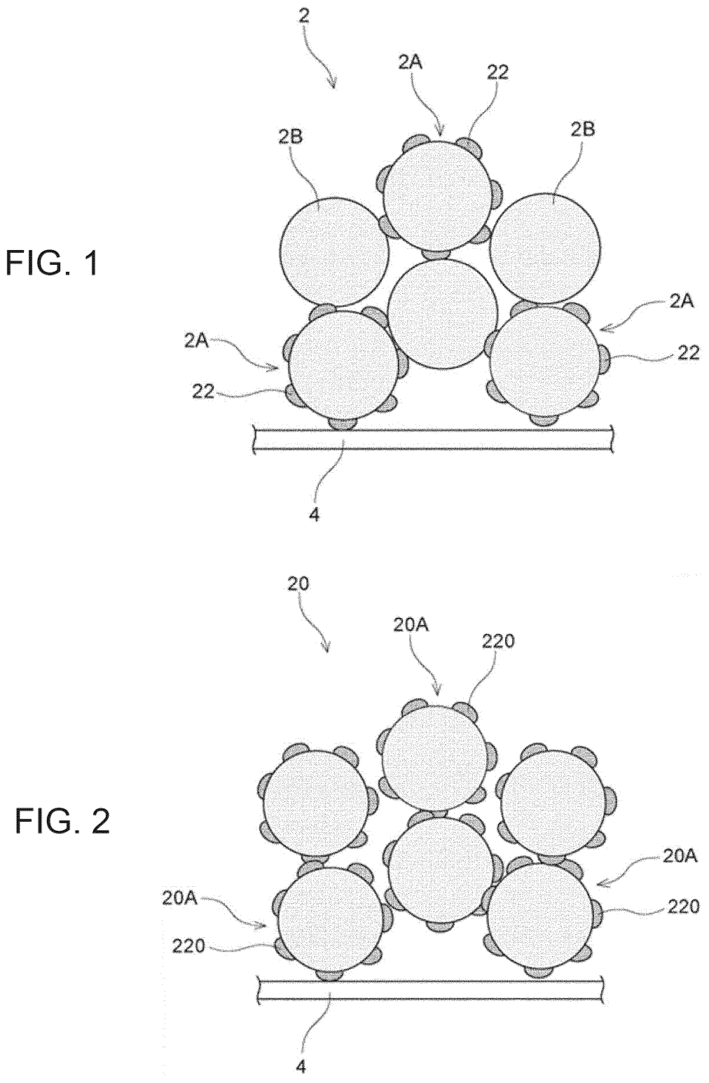

On the other hand, an example of a positive electrode active material according to the embodiment of the present disclosure is shown in FIG. 1. FIG. 1 is a schematic sectional view showing an example of the positive electrode active material according to the embodiment of the present disclosure. A positive electrode active material layer 2 shown in FIG. 1 is formed such that first active material particles 2A and second active material particles 2B are accumulated on the current collector 4. The first active material particle 2A is an active material particle that includes, on the surface, coatings 22 each of which contains the compound of the element expressed as the above-described M (M element), and the second active material particle 2B is an active material particle that does not include the coating 22 on the surface. In the active material (that is, the first active material particle 20A and the second active material particle 20B) included in the positive electrode active material layer 2, the particle that includes the coating 22 on the surface and the particle that does not include the coating 22 on the surface are blended, and the sphericity standard deviation (Z) of the active material particle is high (specifically, 0.018 or higher).

In the positive electrode active material layer 2 including the active material particle having a high sphericity standard deviation (Z), voids among active material particles are small, as shown in FIG. 1. Therefore, even when the positive electrode active material layer 2 is pressed (compressed), the strong force is restrained from locally acting on active material particles, and the generation of the crack on the active material (that is, the first active material particle 20A and the second active material particle 20B) is restrained.

Next, the positive electrode active material according to the embodiment of the present disclosure will be described in detail.

### Composition

The positive electrode active material according to the embodiment of the present disclosure includes a positive electrode active material particle that has a composition expressed as LiₓNiₐCo_{b}Mn_{c}M_{d}O_{y} (in the composition, 0.1≤x≤1.5, 0.5≤a≤ 1.0, 0≤b≤0.3, 0≤c≤0.3, 0≤d≤0.1, a+b+c+d=1.0, 1.5≤y≤2.1 are satisfied, and the M expresses at least one kind of element that is selected from the group consisting of B, Nb, W, Sr, Pr, La, Ba, Mg, Al, Zr, Sc, Ti, Y, Hf, and Sn).

In the above composition, the ratio x of Li is 0.1 or higher and 1.5 or lower, preferably should be 0.3 or higher and 1.4 or lower, and more preferably should be 0.5 or higher and 1.2 or lower.

The ratio a of Ni is 0.5 or higher and 1.0 or lower, preferably should be 0.6 or higher and 0.9 or lower, and more preferably should be 0.7 or higher and 0.8 or lower.

The ratio b of Co is 0 or higher and 0.3 or lower, preferably should be 0 or higher and 0.2 or lower, and more preferably should be 0.1 or higher and 0.2 or lower.

The ratio c of the Mn is 0 or higher and 0.3 or lower, preferably should be 0 or higher and 0.2 or lower, and more preferably should be 0.1 or higher and 0.2 or lower.

The ratio d of M is 0 or higher and 0.1 or lower, preferably should be 0.01 or higher and 0.09 or lower, and more preferably should be 0.03 or higher and 0.07 or lower.

The total (a+b+c+d) of the ratios of Ni, Co, Mn, and M is 1.0.

The ratio y of O is 1.5 or higher and 2.1 or lower, preferably should be 1.7 or higher and 2.1 or lower, and more preferably should be 1.9 or higher and 2.0 or lower.

### Sphericity Standard Deviation (Z)

In the positive electrode active material according to the embodiment of the present disclosure, the sphericity standard deviation (Z) of the positive electrode active material particle satisfies Z≥0.018. Since the sphericity standard deviation (Z) satisfies Z≥0.018, the generation of the crack on the positive electrode active material particle is restrained, and when the positive electrode active material is used in the battery, the durability of the battery can be improved.

The sphericity standard deviation (Z) of the positive electrode active material particle preferably should satisfy Z≥0.090, and more preferably should satisfy Z≥0.100, from the standpoint of the restraint of the generation of the crack of the positive electrode active material particle. Further, the upper limit of the sphericity standard deviation (Z) of the positive electrode active material particle is not particularly limited, but preferably should satisfy Z≤0.800, and more preferably should satisfy Z≤0.650, from the standpoint of the improvement in the function as the positive electrode.

### Measurement of Sphericity Standard Deviation (Z)

The sphericity standard deviation (Z) of the positive electrode active material particle in the positive electrode active material is measured by the following method.

First, an image of the positive electrode active material is acquired by a scanning electron microscope (SEM, 5000 power to 20000 power), and the sphericity degree of the particle in the image is calculated using particle analysis software for Explorer4 (Kyokuto Boeki Kaisha, Ltd.). This is repeated until the sphericity degree data of 1000 particles is acquired. Next, the standard deviation is calculated from the sphericity degrees calculated from 1000 particles, so that the sphericity standard deviation (Z) is obtained.

The positive electrode active material in which the sphericity standard deviation (Z) of the positive electrode active material particle satisfies Z≥0.018 (that is, the positive electrode active material having a high sphericity standard deviation (Z)) can be produced by the following method, for example.
(1) A method of obtaining the positive electrode active material by producing active material particles having a wide sphericity distribution (that is, active material particles having various sphericities), by the control of the production method for active material particles
(2) A method of obtaining the positive electrode active material by producing two or more kinds of active material particles having different sphericities (different average sphericities) and thereafter blending the two or more kinds of active material particles

A case of obtaining the positive electrode active material according to the embodiment of the present disclosure by the above method (2) (the method of obtaining the positive electrode active material by producing two or more kinds of active material particles having different sphericities (different average sphericities) and thereafter blending the two or more kinds of active material particles) will be described with an example.

### First Active Material Particle and Second Active Material Particle

For example, the positive electrode active material according to the embodiment of the present disclosure preferably should be a positive electrode active material that includes the first active material particle that includes, on the surface, the coating that contains the compound of the element expressed as the M (M element) and the second active material particle that does not include the coating on the surface.

The positive electrode active material that includes the first active material particle that includes, on the surface, the coating that contains the compound of the M element and the second active material particle that does not include the coating on the surface has the configuration of the positive electrode active material included in the positive electrode active material layer 2 shown in FIG. 1, for example. As shown in FIG. 1, the first active material particle 2A that includes, on the surface, the coating 22 that contains the compound of the M element has an awkward shape because the coating 22 exists on the surface, and on the other hand, the second active material particle 2B that does not include the coating 22 on the surface has a shape similar to a spherical shape. Therefore, the sphericity standard deviation (Z) is high as the whole of the positive electrode active material.

Accordingly, the positive electrode active material according to the embodiment of the present disclosure preferably should be a positive electrode active material including the first active material particle that includes, on the surface, the coating that contains the compound the element expressed as the M (M element) and the second active material particle that does not include the coating on the surface, because the sphericity standard deviation (Z) is easily controlled so as to be in the above-descried range and thereby the generation of the crack of the positive electrode active material particle is restrained.

In the case where the positive electrode active material includes the first active material particle that includes the coating on the surface and the second active material particle that does not include the coating on the surface, the mass ratio of the first active material particle to the second active material particle (first active material particle/second active material particle (mass %)) preferably should be 10 mass % to 90 mass %, more preferably should be 20 mass % to 80 mass %, and further preferably should be 40 mass % to 60 mass %.

The composition of each particle in the case where the positive electrode active material includes the first active material particle that includes the coating on the surface and the second active material particle that does not include the coating on the surface will be described.

The first active material particle that includes the coating on the surface preferably should have a composition expressed as Liₓ₁Niₐ₁Co_{b1}Mn_{c1}M_{d1}O_{y1} (in the composition of the first active material particle, 0.1≤x1≤1.5, 0.5≤a1≤1.0, 0≤b1≤0.3, 0≤c1≤0.3, 0≤d1≤0.1, a1+b1+c1+d1=1.0, 1.5≤y1≤2.1 are satisfied, and the M expresses at least one kind of element that is selected from the group consisting of B, Nb, W, Sr, Pr, La, Ba, Mg, Al, Zr, Sc, Ti, Y, Hf, and Sn).

The second active material particle that does not include the coating on the surface preferably should have a composition expressed as Liₓ₂Niₐ₂Co_{b2}Mn_{c2}O_{y2} (in the composition of the second active material particle, 0.1≤x2≤1.5, 0.5≤a2≤1.0, 0≤b2≤0.3, 0≤c2≤0.3, a2+b2+c2=1.0, 1.5≤y2≤2.1).

Although FIG. 1 shows the positive electrode active material including the first active material particle 2A that includes, on the surface, the coating 22 that contains the compound of the M element and the second active material particle 2B that does not include the coating 22 on the surface, the present disclosure is not limited to this manner. For example, an active material particle having a different sphericity (different average sphericity) from the first active material particle and the second active material particle may be further included in addition to the first active material particle and the second active material particle. That is, three or more kinds of active material particles having different sphericities (different average sphericities) may be included.

### Manufacturing Method for Positive Electrode Active Material

A method for manufacturing the positive electrode active material according to the embodiment of the present disclosure will be described with an example. As an example, a manufacturing method for the positive electrode active material including the first active material particle that includes, on the surface, the coating that contains the compound of the M element and the second active material particle that does not include the coating on the surface will be described below.

The positive electrode active material including the first active material particle and the second active material particle can be manufactured, for example, by separately preparing the first active material particle and the second active material particle and thereafter blending both particles.

### Preparation of Second Active Material Particle Including No Coating

First, a preparation method for the second active material particle that does not include the coating on the surface will be described. For example, the second active material particle can be prepared by the following steps (1) to (5).
(1) A step of making a solution in which raw materials containing Ni, Co and Mn respectively are dissolved (raw material dissolution)
(2) A step of adding the solution in an alkaline solution and precipitating hydroxides (crystallization)
(3) A step of taking the precipitate out of the alkaline solution
(4) A step of blending the precipitate and a raw material containing Li and obtaining a blended material (Li raw material addition)
(5) A baking step of baking the blended material (baking)

(The M expresses at least one kind of element that is selected from the group consisting of B, Nb, W, Sr, Pr, La, Ba, Mg, Al, Zr, Sc, Ti, Y, Hf, and Sn)

(1) Step of Making Solution in which Raw Materials Containing Ni, Co and Mn Respectively are Dissolved

A solution in which a raw material containing Ni, a raw material containing Co and a raw material containing Mn are dissolved is made. For example, the solution can be made by dissolving the raw material containing Ni, the raw material containing Co and the raw material containing Mn in a solvent such as water. The concentration of the solution preferably should be in a range of 10 mass % to 40 mass %, for example. The ratio of Ni/Co/Mn preferably should be 1.0/0.8 to 1.2/0.8 to 1.2 (atm %) with respect to Ni: 1.0.

Examples of the raw material containing Ni include a sulfate such as NiSO₄, examples of the raw material containing Co include a sulfate such as CoSO₄, and examples of the raw material containing Mn include a sulfate such as MnSO₄.

### (2) Step of Adding Solution in Alkaline Solution and Precipitating Hydroxides

Next, the solution is added in the alkaline solution, and hydroxides are precipitated. Thereby, particles in which hydroxides containing Ni, Co and Mn are generated are crystallized, and the particles are obtained as a precipitate. In this step, for example, while an alkaline solution in which hydroxides are precipitated is controlled at a certain pH (for example, pH 10 to pH 12), the solution and NH₃ are dropped, and thereby, hydroxides of transition metals are precipitated.

### (3) Step of Taking Precipitate Out of Alkaline Solution

Next, the precipitate is taken out of the alkaline solution.

Examples of the method for taking out the particle of precipitate include a method of performing filtration and water washing. In this method, first, the precipitate (particles) was taken out by filtration and is washed with water, and the liquid after the water washing is further filtered, so that the precipitate (particles) is taken out. The precipitate (particles) after the water washing may be further dried.

### (4) Step of Blending Precipitate and Raw Material Containing Li and Obtaining Blended Material

Next, the taken precipitate (particles) and a raw material containing Li are blended, so that a blended material is obtained. For example, the particles of the taken precipitate and the raw material containing Li can be blended in a mortar.

Examples of the raw material containing Li include Li₂CO₃ and LiOH.

### (5) Baking Step of Baking Blended Material

Next, the blended material of the taken precipitate (particles) and the raw material containing Li is baked. For example, the blended material can be baked by a baking furnace (a muffle furnace or the like). As the condition for the baking, for example, the baking can be performed at a temperature of 800° C. to 1100° C. under an oxygen atmosphere for 5 hours to 20 hours.

The blended material after the baking may be crushed such that the blended material has a predetermined particle size. Examples of the method for the crushing include a method such as grinding with a grinding machine (for example, a jet mill).

By performing the steps (1) to (5), it is possible to obtain the second active material particle that does not include the coating on the surface.

### Preparation of First Active Material Particle Including Coating

The first active material particle can be prepared, by altering “(4) Step of Blending Precipitate and Raw Material Containing Li and Obtaining Blended Material”, to “(4′) Step of Blending Precipitate, Raw Material Containing Li and Raw Material Containing M Element and Obtaining Blended Material” described below, in the above-described “Preparation of Second Active material Particle Including No Coating”.

### (4′) Step of Blending Precipitate, Raw Material Containing Li and Raw Material Containing M Element and Obtaining Blended Material

Next, the taken precipitate (particles), a raw material containing Li, and a raw material containing the M element are blended, so that a blended material is obtained. For example, the particles of the taken precipitate, the raw material containing Li, and the raw material containing the M element can be blended in a mortar.

Examples of the raw material containing Li include Li₂CO₃ and LiOH.

Examples of the raw material containing the M (at least one kind of element that is selected from the group consisting of B, Nb, W, Sr, Pr, La, Ba, Mg, Al, Zr, Sc, Ti, Y, Hf, and Sn) include oxides of the elements (for example, Nb₂O₅, W₂O₃, SrO, Pr₂O₃, and La₂O₃) and hydroxides of the elements (for example, H₃BO₄).

### Blending of First Active Material Particle and Second Active Material Particle

Next, the obtained first active material particle and second active material particle are blended, and thereby, it is possible to obtain the positive electrode active material according to the embodiment of the present disclosure.

In the above description about the manufacturing method, the positive electrode active material includes two kinds of active material particles: the first active material particle that includes, on the surface, the coating that contains the compound of the M element and the second active material particle that does not include the coating on the surface, but the present disclosure is not limited to this manner. For example, the positive electrode active material according to the embodiment of the present disclosure may be obtained by preparing an active material particle having a different sphericity (different average sphericity) from the first active material particle and the second active material particle, in addition to the first active material particle and the second active material particle, and blending the three kinds of active material particles.

### Battery

A battery according to the embodiment of the present disclosure includes the positive electrode active material according to the embodiment of the present disclosure. For example, the battery includes a negative electrode, a positive electrode, a separator, and an electrolyte.

The battery according to the embodiment of the present disclosure may be a solid-state battery including a solid electrolyte, or may be a liquid-state battery including an electrolytic solution that is a liquid. Further, the battery according to the embodiment of the present disclosure may be a bipolar type battery in which a positive electrode active material layer and a negative electrode active material layer are provided on both surfaces of a current collector having functions of a positive electrode current collector and a negative electrode current collector.

Furthermore, the battery according to the embodiment of the present disclosure may a liquid type battery including an electrolytic solution. Particularly, a non-aqueous electrolytic solution is preferable.

### Use Application

For example, the battery can be used as a power supply for a hybrid electric vehicle (HEV), a plug-in hybrid electric vehicle (PHEV), a battery electric vehicle (BEV), or the like.

The present disclosure will be described below based on examples. The present disclosure is not limited to the examples at all.

### Example 1

### Synthesis of Positive Electrode Active Material

A positive electrode active material including an active material particle A and an active material particle B was synthesized by a method described below. The active material particle A had a composition expressed as LiₓNiₐCo_{b}Mn_{c}O_{y}, and x, a, b, c, and y were ratios shown in Table 1. The active material particle B had a composition expressed as LiₓNiₐCo_{b}Mn_{c}M_{d}O_{y}, x, a, b, c, d, and y were ratios shown in Table 1, and the elements described in Table 1 were used as the element expressed as the M (M element).

### Synthesis of Active Material Particle A

### Raw Material Solution

A raw material solution was obtained by dissolving NiSO₄, CoSO₄ and MnSO₄ in ion-exchanged water. The ratio of Ni/Co/Mn was 1/1/1 (atm %), and the concentration of the aqueous solution was 30 mass %.

### Crystallization

A certain amount of NH₃ aqueous solution was put in a reaction container, and nitrogen substitution was performed while stirring was performed by a stirrer. In this reaction container, NaOH was added, so that the pH became an alkaline pH. Next, while the interior of the reaction container was controlled at a certain pH (pH 10 to pH 12), the raw material solution and NH₃ were dropped, and transition metal hydroxides were precipitated.

### Water Washing, Filtration, Drying

The precipitated transition metal hydroxides were taken out by filtration, ion-exchanged water was added, stirring was performed by a spoon, dispersion was performed, and water washing was performed.

Next, the liquid after the water washing was filtered, and the transition metal hydroxides were taken out.

Next, the transition metal hydroxides after the filtration were dried at 120° C. for 16 hours, and water was evaporated.

Blending with Li Raw Material

The dried transition metal hydroxides were blended with Li₂CO₃ and LiOH as the Li raw material, in a mortar.

### Baking and Crushing

The blended material of the transition metal hydroxides and the Li raw material was baked at 800° C. to 1100° C. under an oxygen atmosphere for 10 hours, in a baking furnace (muffle furnace). Next, the blended material after the baking was ground by a grinding machine (jet mill), and thereby, the crushing was performed until the particle size became a predetermined particle size. In this way, the active material particle A was obtained.

### Synthesis of Active Material Particle B

The active material particle B was obtained by the same method as “Synthesis of Active Material Particle A”, except that the step of “Blending with Li Raw Material” in “Synthesis of Active Material Particle A” is altered to “Blending with Li Raw Material and M Raw Material” described below.

Blending with Li Raw Material and M Raw Material

The dried transition metal hydroxides were blended with Li₂CO₃ and LiOH as the Li raw material and H₃BO₄ as the M raw material, in a mortar.

### Blending of Active Material Particle A and Active Material Particle B

The obtained active material particle A and active material particle B were blended at a particle ratio A/B (the mass ratio (mass %) of the active material particle A to the active material particle B) described in Table 1, so that a positive electrode active material in Example 1 was obtained.

### Examples 2 to 5, Example 7

Positive electrode active materials in Examples 2 to 5 and Example 7 were obtained similarly to Example 1, except that the M raw material used for the synthesis of the active material particle B in Example 1 was altered from H₃BO₄ to Nb₂O₅ (Example 2), W₂O₃ (Example 3), SrO (Example 4), Pr₂O₃ (Example 5), and La₂O₃ (Example 7).

### Example 6, Example 8

Positive electrode active materials in Example 6 and Example 8 were obtained similarly to Example 7, except that the particle ratio A/B of the active material particle A and the active material particle B (the mass ratio (mass %) of the active material particle A to the active material particle B) in Example 7 was altered to the particle ratios described in Table 1.

### Comparative Example 1

The “active material particle A” synthesized in Example 1 was used as the positive electrode active material in Comparative Example 1.

### Comparative Example 2

The “active material particle B” synthesized in Example 2 was used as the positive electrode active material in Comparative Example 2.

### Comparative Example 3

The “active material particle B” synthesized in Example 3 was used as the positive electrode active material in Comparative Example 3.

As in the case of Examples 1 to 8, a method of obtaining the positive electrode active material by separately synthesizing an active material particle synthesized by adding the M raw material and an active material particle synthesized without adding the M raw material and blending both active material particles is referred to as a “synthesis method 1” in the embodiment. Further, as in the case of Comparative Examples 1 to 3, a method of synthesizing only the active material particle synthesized without adding the M raw material or only the active material particle synthesized by adding the M raw material and using the synthesized active material particle as the positive electrode active material is referred to a “synthesis method 2” in the embodiment.

### Measurement of Sphericity Standard Deviation (Z)

For each of the positive electrode active materials obtained in Examples 1 to 8 and Comparative Examples 1 to 3, the sphericity standard deviation (Z) of the positive electrode active material particle was measured by the following method.

First, an image of the positive electrode active material was acquired by a SEM (5000 power to 20000 power), and the sphericity degree of the particle in the image was calculated using particle analysis software for Explorer4 (Kyokuto Boeki Kaisha, Ltd.). This was repeated until the sphericity degree data of 1000 particles was acquired. Next, the standard deviation was calculated from the sphericity degrees calculated from 1000 particles, so that the sphericity standard deviation (Z) was obtained.

### Production of Cell

Cells were produced using the positive electrode active materials obtained in the examples and the comparative examples.

### Cell Configuration

### Winding Cylinder

Positive electrode composition: positive electrode active material/acetylene black (electric conducting material)/polyvinylidene fluoride=88/10/2 (mass %)

Negative electrode composition: natural graphite/styrene-butadiene rubber (SBR)/carboxymethyl cellulose (CMC)

Electrolytic solution composition: electrolyte=LiPF₆ (1M), solvent=ethylene carbonate (EC)/dimethyl carbonate (DMC)/ethyl methyl carbonate (EMC)=3/4/3 (volume %)

### Production of Electrode

A positive electrode and a negative electrode were applied on current collectors by a film applicator with film thickness adjustment function (Allgood company), and were dried at 80° C. for 5 minutes by a drier, so that a cell was produced.

### Measurement of After-Cycle Resistance Increase Rate

For each of the cells obtained in the examples and the comparative examples, the battery capacity was measured before and after cycles under a test condition described below. The result of the proportion of the battery capacity after the cycles (capacity maintenance rate (%)) when the battery capacity before the cycles is “100%” is shown in Table 1. It can be said that the battery characteristic is higher as the capacity maintenance rate is closer to 100%.

Test condition: The charge and discharge were executed under 60° C. at 2C rate between a SOC of 0% and a SOC of 100% by 300 cycles

TABLE 1

| | | | | | | | | | | | | | | | | | After- |
|---|---|---|---|---|---|---|---|---|---|---|---|---|---|---|---|---|---|
| | | | | | | | | | | | | | | | | | Cycle |
| | | Active Material Particle A | | | | | Active Material particle B | | | | | | | Particle | | Sphericity | Capacity |
| | | Li | Ni | Co | Mn | O | Li | Ni | Co | Mn | O | M | | Ratio | | Standard | Main- |
| | | Ratio | Ratio | Ratio | Ratio | Ratio | Ratio | Ratio | Ratio | Ratio | Ratio | | Ratio | A/B | Synthesis | Deviation | tenance |
| | | x | a | b | c | y | x | a | b | c | y | Kind | d | mass % | Method | Z | Rate % |
| Comparative | 1 | 1.1 | 0.8 | 0.1 | 0.1 | 2.0 | — | — | — | — | — | — | — | — | 1 | 0.009 | 80 |
| Example | 2 | — | — | — | — | — | 1.1 | 0.8 | 0.1 | 0.1 | 2.0 | Nb | 0.05 | — | 1 | 0.012 | 79 |
| | 3 | — | — | — | — | — | 1.1 | 0.8 | 0.1 | 0.1 | 2.0 | W | 0.05 | — | 1 | 0.014 | 78 |
| Example | 1 | 1.1 | 0.8 | 0.1 | 0.1 | 2.0 | 1.1 | 0.8 | 0.1 | 0.1 | 2.0 | B | 0.05 | 50 | 2 | 0.020 | 85 |
| | 2 | 1.1 | 0.8 | 0.1 | 0.1 | 2.0 | 1.1 | 0.8 | 0.1 | 0.1 | 2.0 | Nb | 0.05 | 50 | 2 | 0.092 | 93 |
| | 3 | 1.1 | 0.8 | 0.1 | 0.1 | 2.0 | 1.1 | 0.8 | 0.1 | 0.1 | 2.0 | W | 0.05 | 50 | 2 | 0.102 | 89 |
| | 4 | 1.1 | 0.8 | 0.1 | 0.1 | 2.0 | 1.1 | 0.8 | 0.1 | 0.1 | 2.0 | Sr | 0.05 | 50 | 2 | 0.324 | 97 |
| | 5 | 1.1 | 0.8 | 0.1 | 0.1 | 2.0 | 1.1 | 0.8 | 0.1 | 0.1 | 2.0 | Pr | 0.05 | 50 | 2 | 0.422 | 86 |
| | 6 | 1.1 | 0.8 | 0.1 | 0.1 | 2.0 | 1.1 | 0.8 | 0.1 | 0.1 | 2.0 | La | 0.05 | 20 | 2 | 0.632 | 85 |
| | 7 | 1.1 | 0.8 | 0.1 | 0.1 | 2.0 | 1.1 | 0.8 | 0.1 | 0.1 | 2.0 | La | 0.05 | 50 | 2 | 0.367 | 95 |
| | 8 | 1.1 | 0.8 | 0.1 | 0.1 | 2.0 | 1.1 | 0.8 | 0.1 | 0.1 | 2.0 | La | 0.05 | 80 | 2 | 0.532 | 86 |

Table 1 reveals that the positive electrode active material in each example in which the sphericity standard deviation (Z) is high, with 0.018 or higher keeps the capacity maintenance rate after the cycles at a higher rate than the positive electrode active material in each comparative example in which the sphericity standard deviation (Z) is low, with lower than 0.018.

What is claimed is:

1. A positive electrode active material comprising a positive electrode active material particle that has a composition expressed as LiₓNiₐCo_{b}Mn_{c}M_{d}O_{y}, a sphericity standard deviation (Z) of the positive electrode active material particle satisfying Z≥0.018 (in the composition, 0.1≤x≤1.5, 0.5≤a≤1.0, 0≤b≤0.3, 0≤c≤0.3, 0≤d≤0.1, a+b+c+d=1.0, 1.5≤y≤2.1 are satisfied, and the M expresses at least one kind of element that is selected from the group consisting of B, Nb, W, Sr, Pr, La, Ba, Mg, Al, Zr, Sc, Ti, Y, Hf, and Sn).

2. The positive electrode active material according to claim 1, wherein the sphericity standard deviation (Z) satisfies 0.090≤Z≤0.800.

3. The positive electrode active material according to claim 1, comprising:
a first active material particle that includes a coating on a surface, the coating containing a compound of the element expressed as the M; and
a second active material particle that does not include the coating on the surface.

4. A battery comprising the positive electrode active material according to claim 1.
